(19) United States
(12) Patent Application Publication
(10) Pub. No.: US 2007/0180087 A1
(43) Pub. Date: Aug. 2, 2007

(54) Computer allocation method

(75) Inventors: Yuji Mizote, Kamakura (JP); Kiyoshi Takahara, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/351,858

(22) Filed: Feb. 9, 2006

(30) Foreign Application Priority Data
Dec. 12, 2005 (JP) 2005-357114

(51) Int. Cl. G06F 9/46; G06F 15/173

(52) U.S. Cl. 709/223; 718/104

(57) ABSTRACT

A rule evaluation unit classifies users into users of fixed PC allocation and users of dynamic allocation according to the user utilization characteristic and stores the classification result in a user classification table. When a user makes a PC utilization request, a PC allocation unit allocates a predetermined PC to a user of fixed PC allocation and allocates an empty PC in the PC pool to a user of dynamic allocation. Moreover, a volume rearrangement unit executes volume migration so as to equalize the I/O performance of the physical disks in the storage device according to the user utilization characteristic.

### INCORPORATION BY REFERENCE

This application relates to and claims priority from Japanese Patent Application No. 2005-357114 filed on Dec. 12, 2005, the entire disklosure of which is incorporated herein by reference.

### BACKGROUND OF THE INVENTION

The present invention relates to resource allocation of a personal computing system having a computer and a storage device.

Recently, various types of personal computers such as a desktop computer and a notebook type computer (hereinafter, referred to as PC) are used by company staffs so as to efficiently perform jobs. Since the storage device in the PC now has a large capacity, it has become possible to store a large amount of confidential data of a company in the storage device of the PC, which in turn causes a social problem of information leak by a loss of notebook type PC or theft of a desktop PC.

In order to prevent this information leak, there is a method for a user to use a PC containing confidential data and arranged in a place where management can be performed by locking without carrying the PC out of the place, the PC having a limited function called thin client including a screen display function, an I/O function, and a function for connection to the PC from a remote place (in this specification, the term “thin client” is used in this sense), so that the user utilizes the thin client to make a connection to the PC from a remote place and uses the function provided by the PC. The thin client acquires screen information of the program executed on the PC from the PC for display. The I/O operation (a mouse, a keyboard, etc.) information on the thin client is sent to the PC and processed by the program on the PC. The thin client performs only the screen display and the I/O data transmission and reception. The confidential information of the company is stored in the PC stored in the place which is managed by locking and not held in the storage device in the thin client. Accordingly, even if the thin client is lost or robbed, there is no danger of leak of confidential data.

The thin client divides the functions realized by the conventional PC into the user interface function including the screen display and I/O control function, and the computing function for executing the program and storing the data.

US 2004/0153694A1 diskloses a technique in which a PC has a built-in non-volatile memory device such as a disk and a Compact Flash (registered trade mark) instead of making the PC completely disk-less and the non-volatile memory device is operated as a storage I/O cache, thereby reducing the load of the network and the storage device and preventing lowering of reliability of the I/O access during network congestion.

In the method of US 2004/0153694A1, cache data of a particular user is stored in the non-volatile memory device and it is necessary to purge the cache data held in the non-volatile memory device when diskonnecting the PC from the thin client. When no purge is performed and another user uses the PC via the thin client, the cache of the another user may remain in the non-volatile memory device and there arises a contradiction between the cache data and the data on the storage device. Moreover, when a user performs a purge each time use of the PC is stopped, the cache cannot be used when using the PC next time and a large amount of I/O are generated upon OS boost. Moreover, when a purge is performed, the difference from the cache mechanism of the memory level realized by the file system is not clear and there is no significant merit of using the non-volatile memory device as a cache.

Moreover, the method of US 2004/0153694A1 does not sufficiently uses the utilization characteristic unique to a user and depends on the local I/O access pattern between the PC and the storage device, thus limiting the normalization of the performance. On the other hand, there are a plenty of users who use the aforementioned environment in the personal computing environment including the thin client, the personal computer, and the storage device. However, US 2004/0153694A1 cannot realize the personal computing environment in accordance with the utilization characteristic of the user.

Moreover, the storage access pattern may be different depending on the utilization pattern of the user. Optimization in the storage device such as optimization of the volume location can be considered in accordance with the utilization characteristic of the user. US 2004/0153694A1 does not sufficiently utilize the user utilization characteristic information and only the cache level is optimized without realizing optimization of the storage device itself.

### SUMMARY OF THE INVENTION

It is therefore an object of the present invention to realize fixed allocation and dynamic allocation according to the user utilization characteristic in the personal computing environment including a plurality of computers and storage systems.

According to the user personal computing environment utilization characteristic, users classified into two types: “dynamic allocation user” and “fixed allocation user”. This classification is performed by an acquisition/recording unit for acquiring and recording a policy rule defined in advance by an administrator, user PC utilization result information, and user utilization information such as the number of I/O generations of the storage device from the PC used by the user, and a unit for evaluating the policy rule by referencing the user utilization information. For the users of fixed allocation, a particular PC is selected from the pooled PC group and the PC is associated with the user as a fixed allocation PC. When a fixed PC is allocated to a user having a high utilization frequency, i.e., a user substantially occupying one PC, no problem arises for effective utilization of the resource. On the contrary, when it is known in advance that the user has a high utilization frequency, it is possible to realize optimization by the means which will be detailed later.

Moreover, a non-volatile memory device is arranged in each PC and the non-volatile memory device is used as a cache for the storage I/O. However, for a user of the dynamic allocation, control is performed to use the PC like a disk-less computer without utilizing the cache. On the other hand, when using the PC for a user of the fixed allocation, control is performed to use a fixed PC allocated in advance and to use the cache data in the non-volatile memory device.

Moreover, when a user utilizes the personal computing environment, the PC of the fixed allocation is allocated for a user of the fixed allocation while an empty PC is allocated as a dynamic allocation PC for a user of the dynamic allocation.

Moreover, the storage I/O state is monitored. When the storage load is lower than the reference specified by the administrator in advance, the cache data in the non-volatile memory device in the PC correlated to the user of the fixed allocation is synchronized with the volume of each user in the storage device.

Moreover, according to the user utilization characteristic, there is also provided a process for leveling the I/O performance of the physical disk in the storage device.

According to the present invention, it is possible to select a resource allocation and a resource utilization method according to the user utilization characteristic in a system including a plurality of computers and a storage system.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing brief configuration of a computer system according to the present invention.

FIG. 2 is a block diagram showing brief configuration of a typical computer used in the present invention.

FIG. 3 shows an example of table structure of a PC management table.

FIG. 4 shows an example of table structure of a user classification table.

FIG. 5 shows an example of a policy rule.

FIG. 6 shows an example of a processing flow of evaluation of the policy rule.

FIG. 7 shows an example of a processing flow performed when the user allocation state is switched from dynamic allocation to fixed allocation.

FIG. 8 shows an example of a processing flow performed when the user allocation state is switched from fixed allocation to dynamic allocation.

FIG. 9 shows an example of a processing flow of synchronization between a cache and a storage device.

FIG. 10 shows an example of a processing flow performed when a user makes a PC use request.

FIG. 11 shows an example of a function of volume migration in accordance with the user utilization characteristic.

FIG. 12 shows an example of data structure used in the volume migration.

### DETAILED DESCRIPTION OF THE EMBODIMENTS

By using the SAN (Storage Area Network) and the network boot function which have been developed recently, it is possible to divide the computing function into a program execution function and a data storage function. The program execution function is realized by a PC having no built-in disk (when the PC has no built-in disk, the PC is called a disk-less PC) while the data storage function is realized by the SAN storage device. In the aforementioned environment, a volume on the storage device is prepared for each of the users and an OS boot image, an application, and business data are stored in the aforementioned volume. When a user utilizes the computing function via the thin client, an appropriate disk-less PC is dynamically allocated for the user and the OS image unique to the user is booted from the storage device. As has been described above, a PC is dynamically allocated when the user of the thin client uses the personal computing function. This is called dynamic allocation.

On the other hand, the fixed allocation means that PC allocation is performed by deciding in advance the PC to be used by the user and building a user environment in the PC.

The network boot means a boot method for downloading an OS image stored in an external storage device or a server into a memory via a network such as the Ethernet (registered trade mark) and starting (activating) the OS.

The merit of this dynamic allocation is that there is no need of allocating a dedicated PC to all the thin client users and it is sufficient to prepare the disk-less PC for the number of simultaneous users, thereby reducing the cost of introduction of the PC. Additionally, since the user OS image, application, and data are collected in the external storage device, the operation such as backup is also simplified.

The storage network of the PC environment assumes the IP-SAN using the Ethernet. There is a problem that all the I/O of the PC are storage accesses via the network, which applies a great load to the network and the storage device. Moreover, as compared to the server environment where the accesses are collected by the DB server, an enormous number of users are connected to the storage device in the storage device in the client environment and the storage device should process an enormous number of simultaneous access uses.

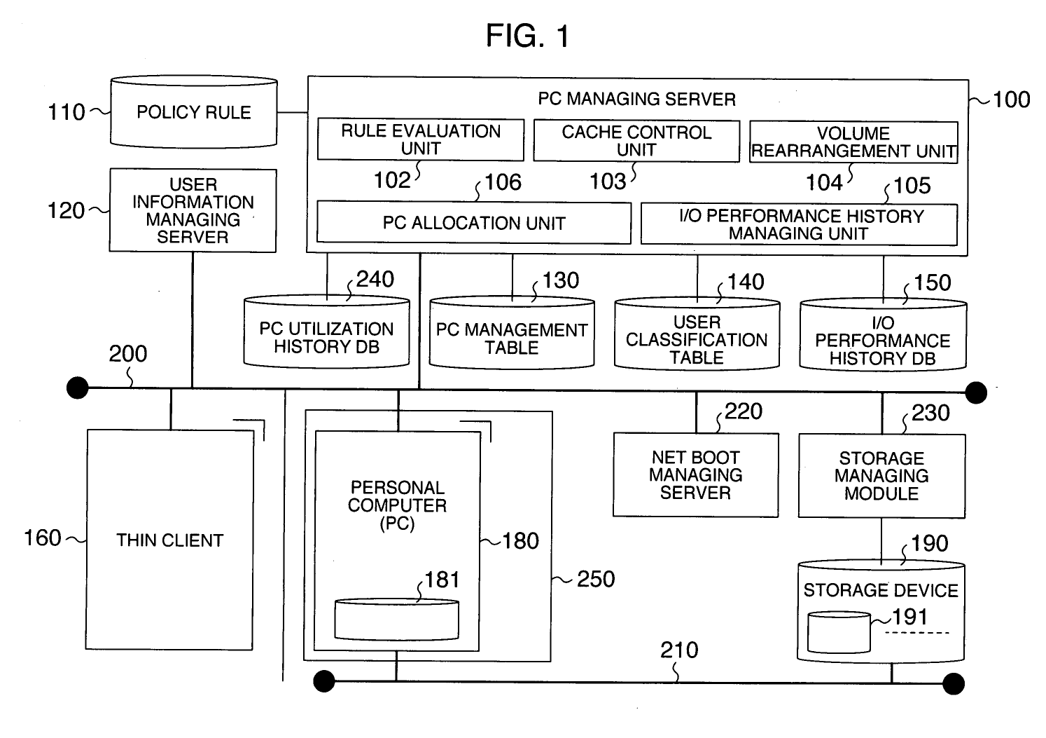

FIG. 1 shows the entire configuration of the present embodiment. A user utilizes the personal computing environment formed by the personal computer (hereinafter, referred to as PC) 180 and a storage device 190 via a thin client 160.

The thin client communicates with the PC 180 via the network. The network is not limited to a cable network but may be a radio network using a radio LAN card or mobile communication card. The PC 180 is connected to the storage device 190 via the network 210.

The same screen information as the screen displayed on the display of the PC 180 is displayed on the display of the thin client 160. The keyboard/mouse input is transmitted from the thin client 160 to the PC 180 and handled as an input to the PC 180. With the aforementioned configuration, it is possible to execute the job of PC 180 from the thin client 160. In this configuration, since the display, keyboard, and mouse of the PC 180 can be operated through the thin client 160, the PC 180 may not have any display, keyboard, and mouse. It is possible to use a computer like a blade machine.

Furthermore, it is possible to connect an external device (a portable medium such as a USB memory, a hard token key, and an IC card) containing authentication data (user identifier (ID), password, or certificate data, etc.) to the thin client 160. In this case, by connecting the external connection device, it is possible to execute a job by using the authentication data stored in the external device by making a connection to the PC 180 from any thin client 160.

By storing the user information to be used, the application to be used, the OS information, and authentication information in the external device, it is possible to transmit these information extracted from the external device, to the PC 180 so as to be used as the authentication information and access information, thereby improving the security and user-friendliness. Moreover, by transmitting these information to the PC managing server 100, the information can be used when deciding whether to perform dynamic allocation or static allocation of the PC 180 in the PC managing server 100.

There are a plurality of personal computers 180 and they are managed as a PC pool 250. The thin client 160 and the personal computer 180 are connected to the front network 200. The PC 180 and the storage device 190 are connected to the storage network 210. It is assumed that the storage 190 has a volume 191 to store the OS image, application, and business data. The network configuration described here is an example. The thin client 160 may be connected to a WAN (Wide Area Network) and connected to the front network 200 via a VPN (Virtual Private Network) or connected to the front network 200 by using a wireless LAN.

The storage 190 may be realized as a RAID (Redundant Array Inexpensive Disk) system. The RAID realizes a high reliability by collecting a plurality of physical disk devices into one capacity unit and storing data redundantly in the disk device group. The collected capacity unit is called a physical disk group in this embodiment. Moreover, in general, the RAID system is formed by a plurality of physical disk groups.

When a user utilizes a storage device from the PC, it is necessary to cut out a volume or a unit called LU (Logical Unit) from the physical disk group and disklose as a virtual disk to the PC. Moreover, as an access protocol to the storage device, there are SCSI (Small Computer System Interface) or iSCSI using TCP/IP in the transport layer.

The net boot managing server 220 is a server connected to the storage network 210 and controlling the PC boot when the PC 180 performs network boot. The managing server 220 has various functions such as DHCP (Dynamic Host Configuration Protocol) and TFTP (Trivial File Transfer Protocol).

The storage managing module 230 is a device for managing the storage device 190 and provides control of the volume rearrangement in the storage device 190 and acquisition function of the operation information on the storage device 190 to the PC managing server 100.

As an aspect of the present embodiment, a storage system is assumed to contain the storage 190 and the storage managing module 230 in one case. The PC is connected to the storage system via the LAN (Local Area Network) and SAN (Storage Area Network). Moreover, the storage system may also be accomplished by the NAS (Network Attached Storage) having a storage device.

The PC managing server 100 includes: a rule evaluation unit 102 for classifying users into “users of dynamic allocation” and “users of fixed allocation” by evaluating the policy rule 110; a cache control unit 10-3 for controlling the cache in the PC 180; a volume rearrangement unit 104 for controlling rearrangement of the volumes in the storage device; a PC allocation unit 106 for allocating an appropriate PC 180 to a user according to a user request; and an I/O performance history management unit 105 for accessing the PC 180 and the storage managing module 230 to acquire I/O performance information such as the number of occurrences of page fault and the number of occurrences of the I/O and storing the information in the I/O performance information history DB 150. The PC allocation unit 106 stores the PC allocation state at the current moment in the PC management table 130 and stores the PC utilization history information for each user in the DB 240. The user classification result by the rule evaluation unit 102 is stored in the user classification table 140. These tables are stored in a storage device of the PC managing server 100.

The user managing server 120 is a server for holding profile information concerning a user such as a user name, age, and a duty position. In general, the user profile information is managed by using the LDAP (Light Weight Directory Access Protocol) and the RDBMS (Relational Database Management System).

There is no need of preparing the number of PC 180 identical to the number of users. Only the number of PC 180 identical to the number of simultaneous users assumed should be prepared. Accordingly, the correspondence between the PC 180 utilized by the users and the users is not decided in advance. Users make PC utilization requests via the thin client to the PC allocation unit 106. The PC allocation unit 106 selects usable PC 180, starts activating PC, and returns the aforementioned PC access information (such as IP address) which has been selected, to the thin client.

When a user stops the utilization of PC (or performs PC shut down) via the thin client, the allocation unit 106 updates the table 140 assuming that the aforementioned PC is an unused PC and adds/updates the aforementioned user utilization information to the PC utilization history DB 240.

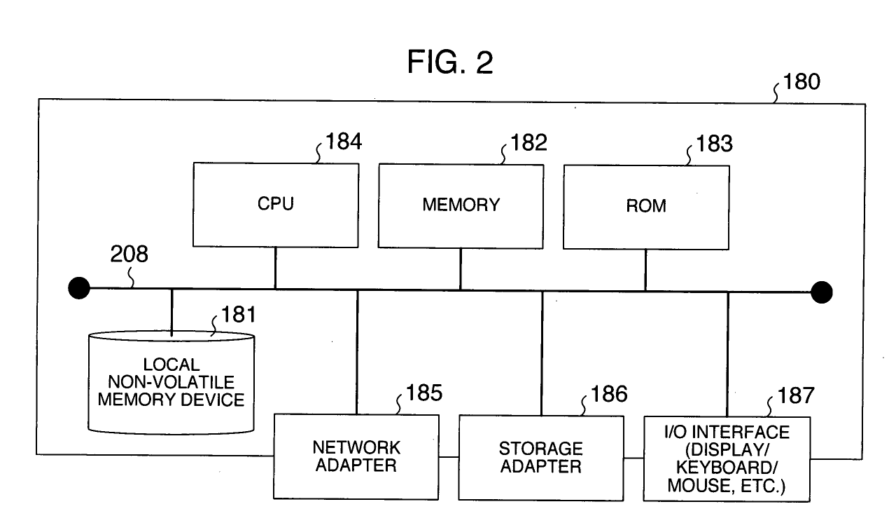

FIG. 2 shows an internal configuration of the PC 180. The PC 180 includes a CPU (central processing unit) 184, a memory 182, a ROM 183, a local non-volatile memory device 181 used as a cache of I/O of a storage device 190, a network adapter 185 connected to a front network 200, a storage adapter 186 connected to the storage network 210, and an I/O interface (mouse, keyboard, display, etc.) 187. They are connected to one another by an internal bus 208. Since the PC 180 is remote-operated by the thin client 160, it may not have an I/O interface.

FIG. 2 shows an example of simplified internal structure of an ordinary PC. The present embodiment is not to be limited to the structure of FIG. 2. Moreover, it is possible to use a blade server as the PC 180. When using the blade server, the PC 180 corresponds to one server blade. Moreover, the PC 180 may be associated with a virtual machine on the virtual machine monitor.

The PC 180 executes the remote server program stored in the memory 182 by the CPU 184, thereby receiving and processing the input information (operation content of the keyboard and the mouse) received from the thin client 160 and transmits image information indicating the processing result (desktop screen displayed on the display) to the thin client 160. The remote server program may be, for example, a server program of the VNC (Virtual Network Computing) developed by AT & T Cambridge Laboratory.

Like the device configuration of FIG. 2, the thin client 160 also has the internal structure including a CPU, a memory, a ROM, a network adapter, an I/O interface, a storage device, and the like. It should be noted that it is sufficient that the thin client communicates with the PC, displays the PC screen information, and has an I/O function. Accordingly, it is general that it has no hard disk. However, the present embodiment is not to be limited to this and an ordinary personal computer having a hard disk may also be used as the thin client.

The thin client executes the remote control program stored in the memory by the CPU, thereby remote-operating the PC from the thin client. The remote control program may be, for example, a client program of the VNC (Virtual Network Computing). The CPU receives the input from the mouse and the keyboard connected to the thin client by executing the remote control program and transmits it to the PC 180. Moreover, the CPU receives image information indicating the processing result transmitted from the PC 180 (desktop screen displayed on the display) and outputs it to the display device of the thin client.

Like the device configuration of FIG. 2, the storage system including the storage device 190 and the storage managing module 230 is also formed by a CPU, a memory, a ROM, a network adapter, an I/O interface, a storage device, and the like. The storage device 190 is managed by the storage managing module 230.

In this embodiment, the local non-volatile memory device 181 is used as a storage area of the I/O cache of the storage device 190.

The present embodiment may employ any volume patterns prepared for the user as follows: (a) a pattern storing an OS image, an application, and business data in one volume (a pattern described in this embodiment); (b) a pattern storing the OS image, the application, and the business data in different volumes; (c) a pattern storing the OS image and the application in one volume and the business data in another volume; and (d) a pattern storing an OS swap area in a separate volume. When storing the OS image and the common application in different volumes, the volumes may also be used as common boot volumes for a plurality of users.

The range of data to be cached on the local non-volatile memory device 181 may vary as follows according to the aforementioned volume utilization patterns: all the entire volumes are fully cached; a particular volume is fully cached, or a part of a volume is cached (partial cache) because of the insufficient cache capacity. The present embodiment may employ any of the aforementioned cache ranges. Moreover, when a hard disk having a sufficiently large storage capacity is used as the local non-volatile memory device 181 and the volume 191 containing a boot image may be fully cached on it, the local non-volatile memory device 181 may also be used as the boot media of the PC 180.

When the local non-volatile memory device 181 is the full cache of volume, the OS may access the storage device 181 as a normal local storage device. On the other hand, when the local non-volatile memory device 181 is a partial cache, it is necessary to process the cache miss. In this case, the processing for performing cache control may be implemented by a layer such as a file system filter driver. When the cache control is required, the cache control is applied only to the PC used basically by the fixed allocation users.

When it is used for the PC used by a dynamic allocation user, this cache is not used. A computer is used in the same way as the disk-less computer, and the OS image, etc. is network-booted from the storage device 190. Here, it is possible to use the local non-volatile memory device 181 as the I/O cache of the storage device 190. In this case, when terminating the use of the PC, the cache data is written back to the volume 191 and the data held by the local non-volatile memory device 181 is purged. It should be noted that the term “purge” means erase or deletion of the file and information.

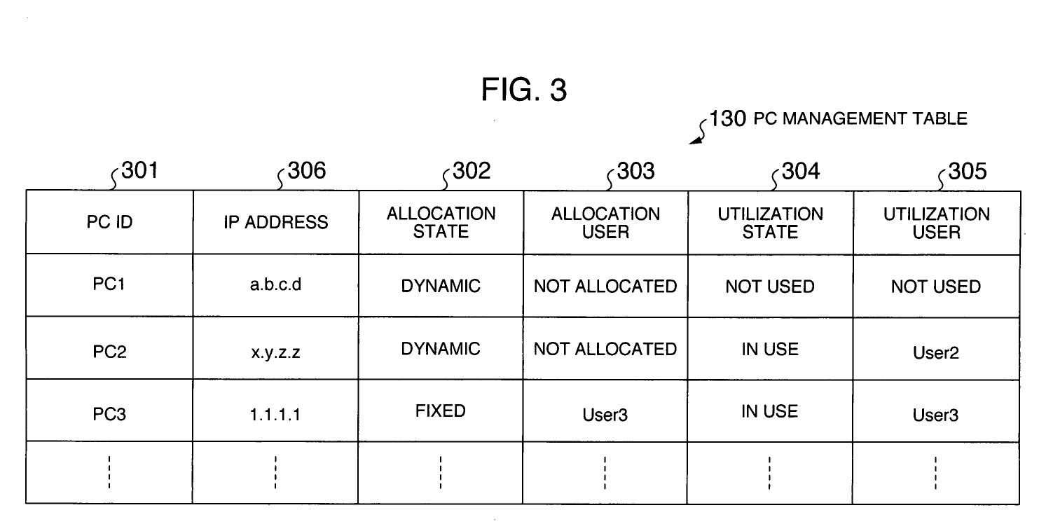

FIG. 3 shows a table structure of the PC management table 130 for managing the information in the PC pool 250 and the PC 180. The table is formed by a PC identifier (ID) 301 as an identifier of the PC 180 pooled in the personal computing environment, an IP address 306, an allocation state 302, an allocation user 303, a utilization state 304, and utilizing user 305.

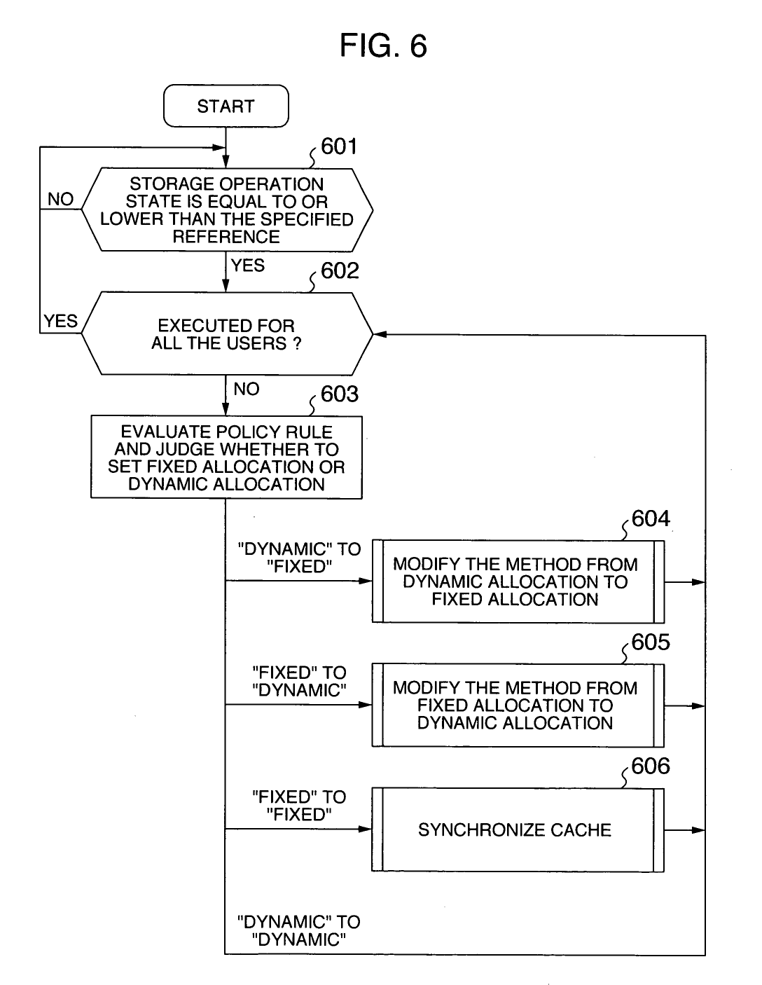

There are four allocations states 302: “dynamic”, “dynamically allocation in progress”, “fixed”, and “fixed allocation in progress”. Normally, “dynamic” is set and “not-allocated” is set for the allocation user 303. According to the rule evaluation by the rule evaluation unit 102, a particular user is classified to the user of fixed allocation and correlated to a particular PC. As a result of this correlation, “fixed” is set for the allocation state 302 of the PC and an identifier of the user is set in the allocation user 303 of the PC. The processing flow of the rule evaluation unit 102 will be detailed with reference to FIG. 6.

The utilization state 304 indicates the utilization state of the PC 180 specified by the PC identifier 301 at the current moment. The utilization state 304 may have a value “in use” or “not used”. When “in use”, the user identifier actually used is set to the utilizing user 305. The state “in use” means the state from the moment when the user has made a utilization request to the PC allocation unit 106 to start the utilization of the PC until the stop of the utilization of the PC by shud down or the like.

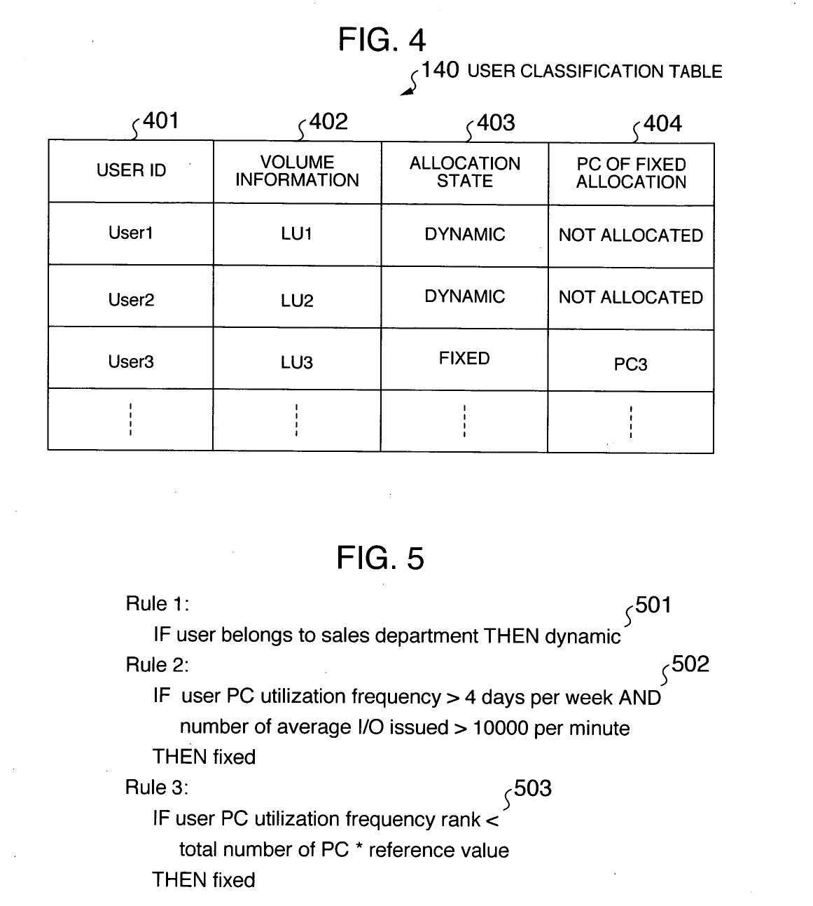

FIG. 4 shows a table structure of the user classification table 140. The table is formed by a user identifier (ID) 401, volume information 402, an allocation state 403, and fixed allocation PC 404.

The volume information 402 stores volume information in the storage device storing the OS image indicated by the user identifier 401, the application, and the business data, i.e., information sufficient for accessing the volume from the PC.

The allocation state 403 may be one of the following four states: “dynamic”, “dynamic allocation in progress”, “fixed”, and “fixed allocation in progress”. Normally, “dynamic” is set and “not allocated” is set for the PC 404 of fixed allocation. According to the rule evaluation of the rule evaluation unit 102, a particular user is classified as a user of fixed allocation and associated with a particular PC. As a result of this association, “fixed” is set for the user allocation state 403 and the identifier of the aforementioned PC is set for the fixed allocation PC 404 of the user. When the allocation state 403 is “dynamic”, “not allocated” is always set for the fixed allocation PC 404.

FIG. 5 shows an example of the policy rule 110 evaluated by the rule evaluation unit 102. The policy rule is a rule of the so-called IF-THEN format. A condition is specified for the IF section. A classification when the condition is satisfied is specified in the THEN section. The condition may describe the user utilization characteristic and the condition expression concerning the user profile. The rule evaluation unit 102 evaluates the condition expression by referencing the data in the user managing server 120, the PC utilization history DB 240, and the I/O performance DB 150.

Rule 1 (501) is an example of the rule based on the user profile information managed by the user information managing server 120. In rule 1, if the user job title is “sales and marketing”, the user is often out and the PC utilization frequency is considered to be low. Accordingly, dynamic allocation is used. The user profile information is stored in the storage device of the user information managing server 120. The profile information may include various attributes such as, in addition to the job title, a position, work location, job content, user ID, user name, and the like.

Assume that “dynamic” or “fixed” is decided according to the user profile information as in rule 1 (501), for example, a job title is specified for the IF section. If the user job title is modified from an office job to sales and marketing, switching between “dynamic” and “fixed” is automatically performed only by modifying the user profile information. That is, the PC allocation may be performed concentrately depending on the user profile information. When an enterprise has an enormous number of staffs, it is possible to use the management information on the staffs used by the enterprise as the user profile information.

Thus, by associating the setting of dynamic and fixed mode with the user profile information, switching between the dynamic and fixed mode is automatically performed when the user job title or position is modified. This reduces the load on the administrator. Moreover, by appropriately managing the profile information, the dynamic and fixed mode management may be performed automatically. Accordingly, by concentrating the management information into the profile information, the security level is improved.

It should be noted that, in term of identifying the profile information on the user utilizing the thin client, the profile information stored in the storage device of the user information managing server 120 is identified from the user ID, user name, password, and the like which has been inputted when the user utilizes the thin client.

Moreover, by fetching the user ID, user name, password, electronic certificate, or the like stored in the external device (mobile medium such as a USB memory, a hard token key, an IC card) connected to the thin client 160 and transmitting it to the PC managing server 100, it is possible to identify the profile information stored in the storage device of the user information managing server 120.

Rule 2 (502) is an example of rule based on the PC utilization history DB 240 for each user and I/O performance history DB 150 for each user. The fixed PC is allocated for the user having a high utilization frequency and frequent I/O issuance, thereby optimizing the I/O.

The PC utilization history DB 240 stores PC utilization information for each user such as the number of utilization of the PC per week, PC utilization time per week, average PC utilization time per day, time band having frequent utilization, a time band for starting the PC, and AP information having a high utilization frequency. The PC utilization information is managed as follows. The PC managing server 100 monitors the PC allocated for the user, accumulates the PC utilization history information in the storage device, and totals them when required.

It is preferable to set a fixed allocation for those who have a high PC utilization frequency such as those who have a great number of PC utilization times per week or those who utilize a PC for a long time per week or those who utilize a PC for a long time per day in average. However, the present embodiment is not to be limited to this.

The I/O performance history DB 150 stores performance information and load information such as the number of I/O issuing times, the data transfer amount, the CPU utilization ratio, memory utilization amount, the storage system disk utilization ratio, and the computer non-volatile memory device utilization ratio by each of the individual users. These information are acquired by the I/O performance history management unit 105 of the PC managing server 100 which monitors the PC allocated to the user and the storage managing module 230 and accumulates information on the I/O state on the PC and the volume access frequency on the storage device.

The number of I/O issuing times, the number of page faults, the data transfer amount, the average CPU utilization ratio, the average memory utilization amount, the storage system disk utilization ratio, the computer non-volatile memory device utilization ratio, and the like per unit time are calculated from the stored performance information, load information, and the like.

It is preferable to set a fixed allocation for a user having a high computer load such as the number of I/O issuing times, the number of page faults, the data transfer amount, the average CPU utilization ratio, the average memory utilization amount. However, the present embodiment is not to be limited to this.

It is possible to modify the mode from “dynamic” to “fixed” or vice versa when the performance information or the load information exceeds a predetermined threshold value by specifying the load information for the condition of the IF section.

Rule 3 (503) shows an example of the rule based on the PC management table 130 and the PC utilization frequency. A reference value is provided for the allocation ratio of the fixed PC so that the fixed PC is allocated for the user having a high PC utilization frequency (a fixed number of PC are used as fixed allocation). The number of PC set to fixed allocation which is calculated by the total number of PC*reference value is compared to the user PC utilization frequency rank so as to decide the fixed PC allocation. The PC utilization frequency rank is decided by referencing the PC utilization history DB 240 so as to rank the users by sorting them by a predetermined item of the PC utilization information for each user such as the number of PC utilization times, the average PC utilization time, the number of PC utilization times per week, the PC utilization time per week, the average PC utilization time per day, a time band of a high utilization frequency, a PC start time band, and the AP information utilized frequently. The total number of PC is decided by counting the number of records by referencing the PC management table 130. When 60% is specified for the reference value, 60% of the total number of PC is set to fixed allocation.

When there are a plurality of rules, there is a case that there may be plural rules satisfying the condition and the contents specified by the THEN sections are different. In such a case, the priority may be provided for each rule or the rules may be sequentially evaluated and the first rule whose condition is satisfied may have a higher priority. Such various meta-rules can be considered for the conflict resolution. The present embodiment may employ various meta-rules, not only the meta-rules mentioned above, concerning the conflict resolution.

Moreover, when the IF sections of all the rules are not satisfied, it is assumed that a default rule of which IF section always satisfies is applied. It is assumed that “dynamic” is specified for the THEN section of the default rule.

Other rules than the rules shown in FIG. 5 can be considered. For example, there may be considered a rule for specifying the least number of PC which can be used for dynamic allocation in order to prevent setting of fixed allocation for all the PC, or a rule for storing the PC boot time of each user in the PC utilization history DB 240 and setting fixed allocation to a part of users of dynamic allocation when there are a plenty of users who boot PC at the same time, thereby preventing the simultaneous boot via the network by the users of dynamic allocation.

In the PC of dynamic allocation, the I/O access reliability may be lowered when the load between the storage device and the PC is high. Moreover, a certain time is required for starting the system because the OS image and the like are network-booted. On the other hand, such a problem does not occur in the PC of fixed allocation.

In FIG. 5, by applying, for example, a rule for making a user having a high utilization frequency utilize a fixed allocation PC and a user having low utilization frequency utilize a dynamic allocation PC, the user having the high utilization frequency can utilize the fixed allocation PC having no reliability lowering of I/O access while the user having the low utilization frequency can utilize the dynamic allocation PC having a possibility of reliability lowering of I/O access. Thus, allocation may be performed by considering the reliability according to the user utilization characteristics.

Moreover, by applying, for example, a rule for making a user who utilizes the PC for a long time utilize a dynamic allocation PC and a user who utilizes a PC frequently but for short time each time utilize a fixed allocation PC, the user who utilizes the PC frequently but for a short time each time can use the fixed allocation PC which can rapidly start, thereby reducing the stress felt by the user.

FIG. 6 shows a processing flow of the user PC fixed/dynamic allocation control. This flow is started at the timing when the PC managing server 100 is started and the processing continues until the PC managing server 100 terminates. However, it is also possible to execute the processes of step 603 to step 606 for a user who has made a PC utilization request at the timing when the request is made.

Firstly, the storage managing module 230 is accessed and the current storage workload information is acquired to judge whether it is not greater than the reference specified in advance (i.e., the storage device load is low) (step 601). Step 601 can specify whether the current time is a specified time (for example, the night time when the number of users are less is specified) or whether the number of users currently utilizing the PC is smaller than a reference. When the result of step 601 is No, step 601 is executed at a certain time interval. When the result of step 601 is Yes, control is passed to step 602.

For all the users on the user classification table 140 (judgment 602), the policy rule is evaluated (step 603).

According to the evaluation result of step 603 and the currently processed user allocation state 403, there are four state changes: the dynamic allocation state is switched to the fixed allocation state; the fixed allocation state is switched to the dynamic allocation state; the fixed allocation state is continuously set (i.e., no allocation state change occurs); the dynamic allocation state is continuously set (i.e., no allocation state change occurs).

When the dynamic allocation state is switched to the fixed allocation state, the process 604 of modifying from the dynamic allocation state to the fixed allocation state is executed.

When the fixed allocation state is switched to the dynamic allocation state, the process 604 of modifying from the fixed allocation state to the dynamic allocation state is executed.

When the fixed allocation state is continuously set, cache synchronization process 606 is executed.

When the dynamic allocation state is continuously set, processing control is returned to step 602.

When the storage device load increases during the processes of the steps 604, 605, 606 and the storage device load exceeds the reference value like judgement 601, the steps 604, 605, 606 may be interrupted and resumed when the reference of judgment 601 is satisfied.

By repeating the user PC fixed/dynamic allocation control process in FIG. 6 and specifying the performance information and the load information in the condition of the IF section like rule 2 in FIG. 5, switching between “dynamic” and “fixed” can be performed when the performance information or the load information exceeds a predetermined threshold value.

The user PC fixed/dynamic allocation processing flow of FIG. 6 may be executed at a certain time interval such as every one hour or may be executed when a predetermined event has occurred, i.e., when a user has issued a PC utilization request or the user stops utilization of the PC. Alternatively the processing flow may be executed at a predetermined date and time such as 0 o'clock every day.

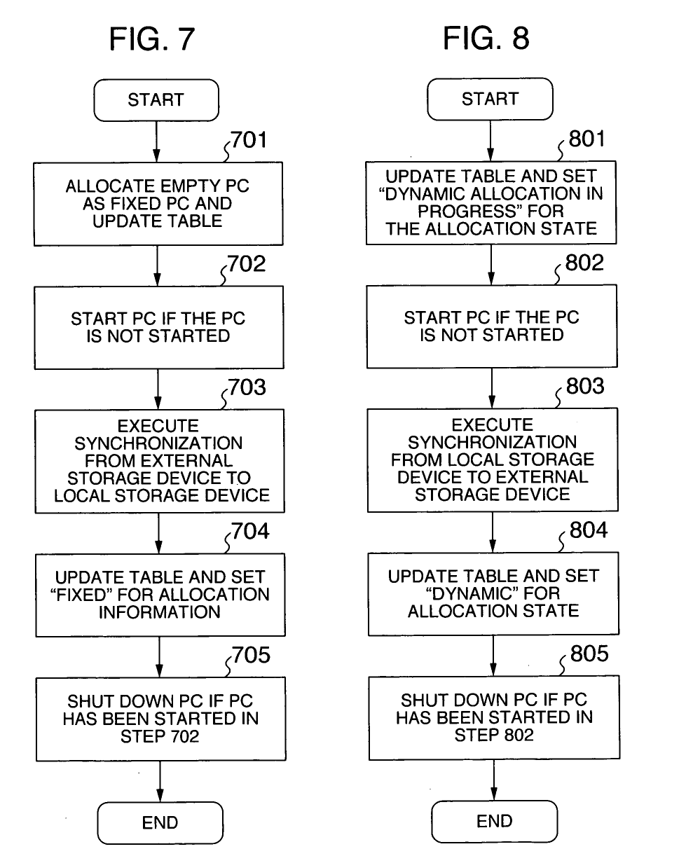

FIG. 7 shows a processing flow for switching from the dynamic allocation state to the fixed allocation state. One empty state PC 180 is selected from the PC pool 250. For the user currently processed, the allocation state 403 is set to “fixed allocation in progress”. The PC identifier is set for the fixed allocation PC 404. For the selected PC 180, the allocation state 302 in the PC management table is set to “fixed allocation in progress”. The user identifier is set for the allocation user 303 (step 701).

Here, the empty state PC 180 means that the allocation state 302 is “dynamic” and the utilization state 304 is “unused”. Even when the allocation state 302 is “fixed”, if the utilization state 304 is “unused”, i.e., the PC 180 is reserved as a fixed PC for a particular user but is not utilized currently. The PC 180 may be considered to be in the empty state. In this case, however, when a dynamic allocation user is utilizing a PC allocated to the fixed allocation user and then any fixed allocation user should utilize the PC, another PC is allocated to the fixed allocation user and network boot is performed or the PC utilized by the dynamic allocation user is made unused.

In step 703, it is necessary to access the data in the local non-volatile device 181 in the PC and accordingly the PC is started if the PC is not started (step 702).

By utilizing the cache control unit 103, data in the user volume on the storage device is loaded in the non-volatile memory device 181 built in the PC (step 703).

The user allocation state 403 currently processed is set to “fixed”. The allocation state 302 of the PC in the PC management table 130 is set to “fixed” (step 704).

When the PC is started in step 702, the PC is stopped (step 705).

FIG. 8 shows a processing flow of switching from the fixed allocation state to the dynamic allocation state. The user allocation state 403 currently processed is set to “dynamic allocation in progress”. The allocation state 302 of the PC in the PC management table 130 is set to “dynamic allocation in progress” (step 801).

Unless the PC 180 specified by the user fixed allocation PC 404 currently processed is being started, the data in the local non-volatile device 181 in the PC should be accessed in step 803 and accordingly, the PC is started (step 802).

By utilizing the cache control unit 103, the cache data stored in the non-volatile memory device 181 built in the PC is written back to the user volume in the storage device 190 (step 803).

The user allocation state 403 currently processed is set to “dynamic” and the fixed allocation PC 404 is set “not allocated”. The allocation state 302 of the PC in the PC management table 130 is set to “dynamic” and the allocation user 303 is set to “not allocated” (step 804).

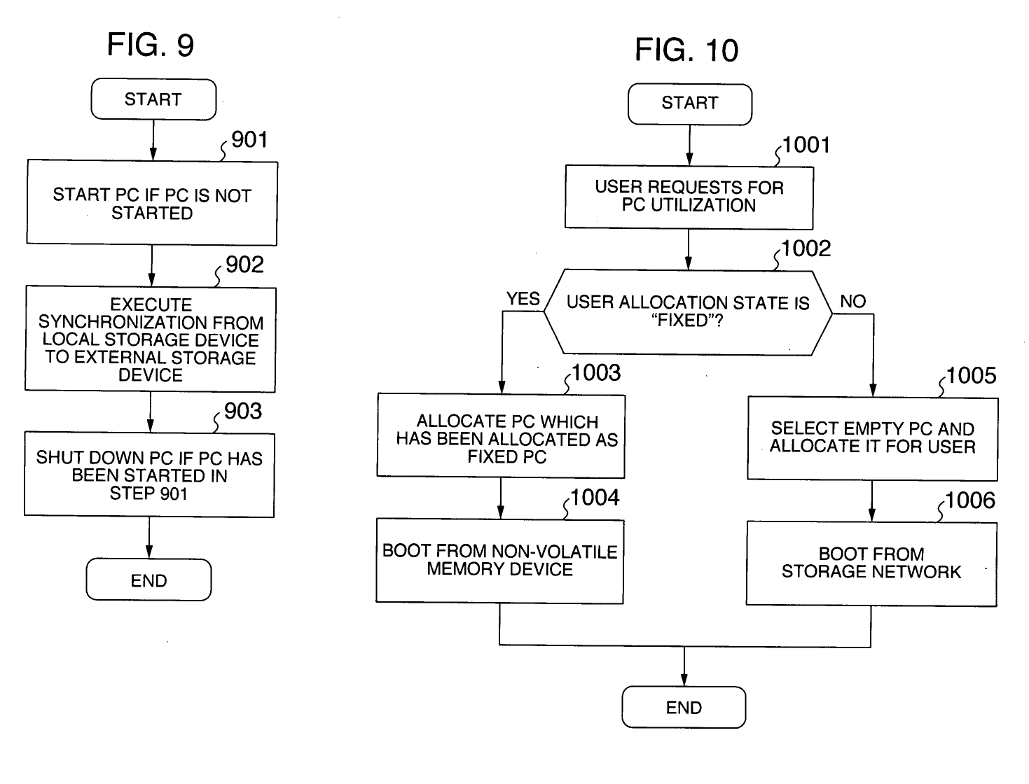

FIG. 9 shows a processing flow of the cache synchronization processing 606. Unless the PC 180 specified by the fixed allocation PC 404 of the user currently processed is being started, the PC is started because the data in the local non-volatile device 181 in the PC should be accessed in step 902 (step 801).

By utilizing the cache control unit 103 for the user currently processed, the cache data of the PC is written back to the volume 191 of the user currently processed (step 902). As for the PC 180 fixedly allocated to the user currently processed and the volume 191, what is necessary is to reference the fixed allocation PC 404 and the volume information 402 in the user classification table 140.

When the PC is started in step 901, the PC is stopped (step 805).

FIG. 10 shows a processing flow performed when the user utilizes the personal computing environment. The user starts the thin client 160 and requests utilization of the PC 180 to the PC allocation unit 106 of the PC managing server 100 (step 1001).

The PC managing server 100 references the allocation state 403 in the user classification table 140 corresponding to the user identifier such as user ID contained in the utilization request sent from the thin client 160 utilized by the user and decides whether the state is “fixed” (judgment 1002).

When Yes in judgment 1002, the PC 180 specified by the fixed allocation PC 404 in the user classification table 140 is made a PC to be utilized by the user currently processed and the utilization state 304 in the PC management table is set to “in use” and a user identifier is set to the utilization user 305 (step 1003).

The PC allocation unit 106 transmits a start command for using the non-volatile memory device 181 in the PC 180 as the boot medium of the PC 180, to the PC 180. Upon reception of the start command, the PC 180 acquires a boot image from the non-volatile memory device 181 specified and executes it in the CPU, there by booting the PC (step 1004). However, when the capacity of the local non-volatile memory device 181 is insufficient and the boot image cannot be full-cached, boot is performed from the user volume 191 instead of the non-volatile memory device 181. If data is cached in the local non-volatile memory device 181, processing can be performed at a higher speed as compared to the boot from the user volume 191 without the cache.

If judgement 1002 results in false, one empty PC is selected from the PC pool 250 and the selected PC is made a PC to be used by the user currently processed. The state “in use” is set in the utilization state 304 in the PC management table 130 and a user identifier of the user currently processed is set in the utilization user 305 (step 1005). The idea of the empty PC is as has been described above. The PC allocation unit 106 makes the boot medium of the PC 180 as the volume 191 of the currently processed user (the volume specified by the volume information 402 in the user classification table 140), acquires information necessary for the net boot such as the boot volume of the PC 180 and the boot volume address information from the net boot managing server 220, and transmits the information necessary for the net boot together with the start command of the PC 180. Upon reception of the start command, the PC 180 acquires the boot image from the storage device 191 in the specified storage system 190 and executes it in the CPU, thereby booting the PC (step 1006).

The PC allocation unit 106 selects a usable PC 180 and starts the PC. After confirming the start by a report from the PC 180 or the like, the PC allocation unit 106 returns the access information (IP address and the like) on the PC 180 started, to the thin client 160 which has transmitted the utilization request.

The thin client 160 transmits a processing request to the IP address specified and remote-controls the PC 180.

In this embodiment, the PC manages the OS image, the application, and the business data as one volume and performs boot from this volume. However, the embodiment is not to be limited to this. Even in dynamic allocation, for example, the OS image and the application default image may be stored in the non-volatile memory device 181 in the PC and only difference information from the default image is stored in the storage device 191 of the storage system, so that the difference information is read from the storage device 191 and combined with the default image in the local PC before performing booting.

The difference information in this case may be stored as a snap shot of the storage device in the storage device 191 of the storage system.

Upon detection of failure of boot in step 1004 or step 1006, a new PC is selected from the empty PC and boot is again performed from the user volume.

The detailed boot flow of the PC 180 cooperated with the net boot managing server 220 assumes PXE (Preboot Execution Environment). The net boot managing server 220 cooperated with the PC managing server 100 passes network setting information such as an appropriate boot loader, volume information and the IP address of the PC to the PC 180. However, the present embodiment is not to be limited to PXE.

Information transmission and reception between the thin client 160, the PC 180, the PC managing server 100, and the storage system are realized by executing the transmission/reception program stored in the respective memories in the respective CPU and the information is transmitted and received via the network adapter.

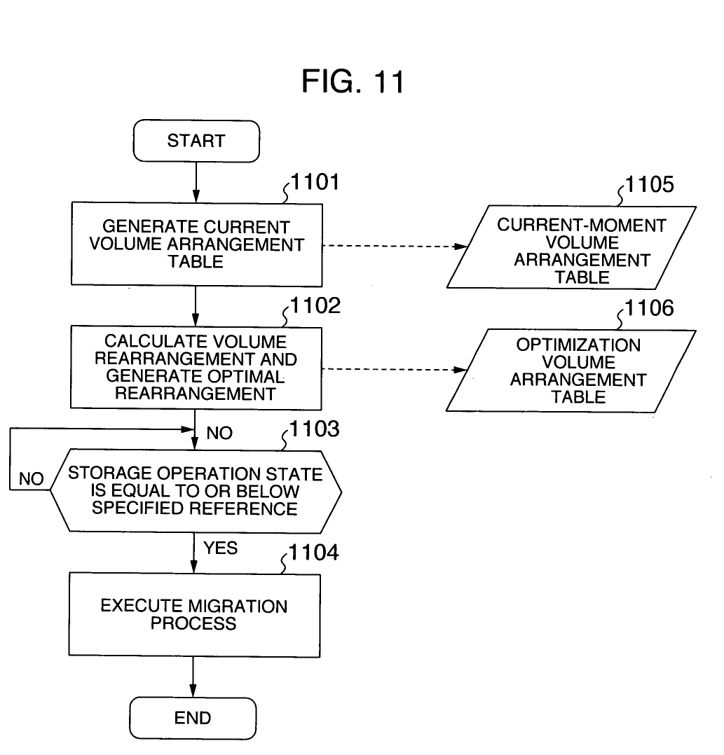

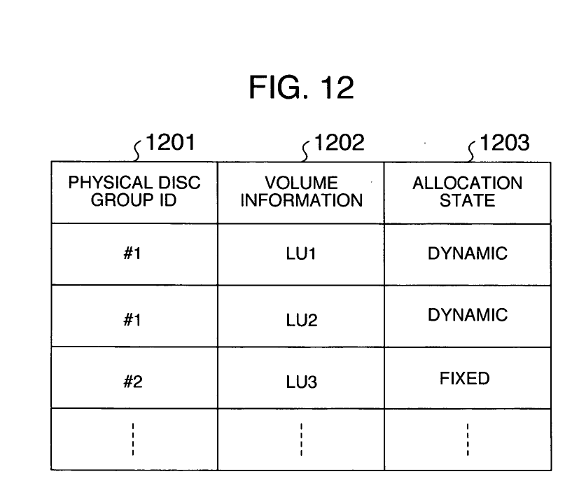

FIG. 11 shows a processing flow for equalizing the volume arrangement in the storage executed by the volume rearrangement unit 104 according to the user PC allocation state 403. FIG. 12 shows a data structure utilized in FIG. 11.

Firstly, explanation will be given on the idea of the volume arrangement equalization. Since the user of fixed allocation effectively utilizes the local non-volatile memory device 181 in the PC as a cache, the number of I/O to the storage is significantly small as compared to the user of dynamic allocation. When the ratios between the volume of the user of dynamic allocation and the volume of the user of fixed allocation vary among the physical disk groups, it becomes a problem in the performance.

When the ratios vary and the physical disk group has a high ratio of users of fixed allocation, the time band of the idle state becomes long. If the physical disk group has a high ratio of users of dynamic allocation, the load of the storage increases and the response is degraded thereby. If it is possible to equalize the ratios between the physical disk group, it is possible to effectively utilize the physical disk group in the idle state, thereby improving the entire performance (such as response) of the storage I/O.

Moreover, when starting the PCs all at once in the morning in an office, many I/O requests to the storage are issued simultaneously from the PCs used by the users of dynamic allocation. In such a case, if the volumes used by the PC of dynamic allocation are equalized in the storage, the load caused by such simultaneously starting may be dispersed.

The term “equalization” means such an arrangement that the volumes of users of fixed allocation and volumes of users of dynamic allocation are dispersed in the physical disk group. The number of volumes of the users of fixed allocation may not be identical to the number of volumes of the users of dynamic allocation. The “dispersed arrangement” means that these volumes are appropriately dispersed in the physical disk group. In general, after the rearrangement, the volumes of users of fixed allocation and the volumes of users of dynamic allocation are more dispersed in the physical disk than before the rearrangement.

Referring to FIG. 12, explanation will be given on the data structure used in the equalization processing. The table shown in FIG. 12 stores the volume allocation information in the storage. This table is called a volume arrangement table. The volume arrangement table is formed by a physical disk group identifier (ID) 1201, volume information 1202, and an allocation state 1202. In FIG. 1, the first record indicates that LU1 belongs to the physical disk group #1 and the user corresponding to the LU 1 is a user of dynamic allocation.

Referring to FIG. 11, the processing flow will be explained. This flow is periodically started. Firstly, by inquiring the storage managing module 230, the physical disk group in the storage and the volume information in the physical disk group are acquired. Next, all the volume information and allocation states are acquired from the user classification table 140 and a volume arrangement table at the current moment is created. This will be called a current-moment volume arrangement table 1105 (step 1101).

Next, by referencing the volume arrangement table 1105, all the combinations of rearrangement of the physical disk group 1201 and the volume information 1202 are enumerated. By using the evaluation function provided in advance, an evaluation value is calculation for each of the combinations. The combination having the best evaluation result is selected from all the combinations and a volume arrangement table corresponding to the combination of the selected rearrangement is generated (step 1102). This volume arrangement table generated will be called an optimization volume arrangement table 1106. The algorithm for generating the optimal rearrangement combination is an algorithm of a typical combination problem and an existing algorithm may be employed.

The evaluation items of the evaluation function may be a deviation of the ratio of the volume of users of dynamic allocation and the volume of users of fixed allocation (what minimizes irregularities in the ratio in each disk group has a good evaluation value), the number of migrations (what minimizes the number has a good evaluation value), a data transfer amount generated by migration (what minimizes the transfer amount has a good evaluation value), and the like. Users classified to dynamic allocation have different storage access frequencies. By referencing the I/O performance history DB 150, the users classified to dynamic allocation are further divided into heavy users and light users concerning the storage access frequency. The deviation of the ratio of the volumes of the heavy users and the light users (what minimizes the irregularities in the ratio in each disk group has a good evaluation value) may be included in the evaluation item.

Next, the storage managing module 230 is accessed to obtain the operation information of the current storage 190 to judge whether it is lower than the reference specified in advance (step 1103). If the result of step 1103 is false, step 1103 is again executed after a predetermined time interval.

If the result of step 1103 is true, for each volume, the current-moment volume arrangement table 1105 is compared to the optimization volume arrangement table 1106. If any modification should be performed in the physical disk group, a command for migrating the volume from the physical disk group of the current-moment volume arrangement table 1105 to the physical disk group of the optimization volume arrangement table 1106 is issued to the storage managing module 230.

Upon reception of the migration command, the storage managing module 230 rearranges the volumes such that the volumes of users of fixed allocation and volumes of users of dynamic allocation in the storage 190 are dispersed.

By using the thin client, it is possible to access the computer in various locations including a visiting destination and within a company. In such an environment, it is necessary to flexibly modify the computer allocation for appropriately allocating the computers in a system having a plurality of computers such as blade servers.

When all the computers are set for fixed allocation, the usable compute resources are limited. For example, when 100 computers exist, only 100 users can utilize the computers. On the other hand, when the computers are set for dynamic allocation, more than 100 users can utilize the 100 computers but the dynamic allocation also has a demerit. For example, when dynamic allocation is set, the non-volatile memory device should be purged each time and it is difficult for the user to customize the computer and store the modified user environment. That is, a certain limit is posed and the user cannot freely utilize the computer. Moreover, when all the computers are set to dynamic allocation, the I/O load on the storage system upon start is increased.

Thus, instead of setting the dynamic allocation or the fixed allocation for all the computers, there is a need of using both of the modes.

For this, in this embodiment, both of the dynamic allocation and fixed allocation are used according to the user utilization environment, the profile information, the computer utilization state, and the like. Dynamic allocation or fixed allocation is set for users satisfying a predetermined rule, thereby flexibly allocating the computers in accordance with the change of the user utilization state.

Moreover, if the administrator should modify the computer allocation method each time user state is changed, the load on the administrator is increased. In this embodiment, the allocation method can be automatically modified according to the rule. This reduces the load on the administrator and enables objective and rational allocation of computers.

Moreover, in the environment including both of the dynamic allocation and the static allocation like in this embodiment, it is possible to increase the performance of the entire system by equalizing the I/O load of the storage connected to the environment and the disk load.

It should be further understood by those skilled in the art that although the foregoing description has been made on embodiments of the invention, the invention is not limited thereto and various changes and modifications may be made without departing from the spirit of the invention and the scope of the appended claims.

1. A computer system comprising a plurality of servers, a client operating the servers, a managing server for managing the servers, and a storage system, wherein
the managing server includes:
information table indicating correspondence between an user identifier and a server allocation method, and
a server allocation unit for selecting a server to be allocated to a client who has transmitted a utilization request, according to a user identifier contained in the utilization request received from the client and the information table indicating the correspondence, transmitting a start request to the selected server, and transmitting address information on the selected server to the client who has transmitted the utilization request;
the client includes:
a transmission/reception unit for transmitting the server utilization request containing the user identifier to the managing server and receiving the address information from the managing server, and
a remote operation unit for remote-operating the server having the address information received from the managing server; and
the server includes:
a reception unit for receiving a start request from the managing server,
a control unit for acquiring information required for start from the storage device according to the start request received from the managing server and starting the server by using the information required for the start, and
a remote operation reception unit for receiving a remote operation from the client.

2. The computer system as claimed in claim 1, wherein the server allocation method stored in the information table is either one of fixed allocation and dynamic allocation,
the server allocation unit of the managing server decides the allocation method of the selected server according to the correspondence,
when the server allocation unit decides to use the fixed allocation, the server allocation unit transmits a start request to employ the storage device of the selected server as the storage device for acquiring information required for the start,
when the server allocation unit decides to use the dynamic allocation, the server allocation unit transmits a start request to employ the storage device of the storage system as the storage device for acquiring information required for the start, and
the control unit of the server acquires the information required for the start from the storage device of the selected server or the storage device of the storage system according to the start request received from the managing server.

3. The computer system as claimed in claim 2, wherein the information required for the start is an OS image.

4. The computer system as claimed in claim 3, wherein the managing server includes an evaluation unit for judging whether to employ the fixed allocation method or the dynamic allocation method as the server allocation method according to server utilization amount corresponding to the user identifier and modifying the information table indicating the correspondence according to the judgment result.

5. The computer system as claimed in claim 3, wherein
the managing server includes:
a storage unit for accumulating server utilization history information corresponding to each of the user identifiers linking with the user identifier, and
an evaluation unit for ranking the servers in the descending order of the server utilization time length according to the utilization history information accumulated in the storage unit, setting fixed allocation for a predetermined number of servers counted from the one having the longest utilization time, and modifying the information table indicating the correspondence by associating the server with the corresponding user identifier.

6. The computer system as claimed in claim 3, wherein the server includes an evaluation unit for judging whether to employ the fixed allocation method or the dynamic allocation method as the server allocation method according to user profile information corresponding to the user identifier and modifying the information table indicating the correspondence according to the judgment result.

7. The computer system as claimed in claim 3, wherein the managing server includes a cache control unit for deleting the information stored in the storage device of the allocated server, according to a utilization end request received from the client when the server allocation method is the dynamic allocation method.

8. The computer system as claimed in claim 3, wherein
the storage device of the storage system includes fixed server areas to be used by servers of fixed allocation and dynamic server areas to be used by servers of dynamic allocation,
a storage management unit for moving the fixed server areas and the dynamic server areas according to an instruction of rearrangement from the managing server, and
the managing server has a volume rearrangement unit for issuing an instruction of rearrangement to the storage system so that the fixed server areas and the dynamic server areas are dispersed in the storage device of the storage system.

9. The computer system as claimed in claim 8, wherein
the storage device of the storage system is a physical volume,
the fixed server areas and the dynamic server areas correspond to logical volumes in the physical volume, and
the storage management unit moves the logical volumes of the fixed server areas and the logical volumes of the dynamic server areas so that the logical volumes of the fixed server areas and the logical volumes of the dynamic server areas are dispersed in the physical volume.

10. A server allocation method for use in a system comprising a plurality of servers, a client operating the servers, a managing server for managing the plurality of servers, and a storage system, wherein
the client transmits a server utilization request containing the user identifier to the managing server,
the managing server selects a server to be allocated for the client who has transmitted the utilization request, according to the user identifier contained in the server utilization request and information table indicating correspondence between an user identifier and a server allocation method, and transmits a start request to the selected server,
the server acquires information required for start from the storage device according to the start request received from the managing server and starts the server by using the information required for the start,
the managing server transmits the address information on the started server to the client who has transmitted the utilization request, and
the client transmits a processing request to the server corresponding to the address information transmitted from the managing server.

11. The server allocation method as claimed in claim 10, wherein the server allocation method stored in the information table is ether one of fixed allocation and dynamic allocation,
a server allocation unit of the managing server decides the allocation method of the selected server according to the correspondence table,
when the server allocation unit decides to use the fixed allocation, the server allocation unit transmits a start request to employ the storage device of the selected server as the storage device for acquiring information required for the start,
when the server allocation unit decides to use the dynamic allocation, the server allocation unit transmits a start request to employ the storage device of the storage system as the storage device for acquiring information required for the start, and
a control unit of the server acquires the information required for the start from the storage device of the selected server or the storage device of the storage system according to the start request received from the managing server.

12. The server allocation method as claimed in claim 11, wherein the information required for the start is an OS image.

13. The server allocation method as claimed in claim 12, wherein the managing server includes an evaluation unit for judging whether to employ the fixed allocation method or the dynamic allocation method as the server allocation method according to a server utilization amount corresponding to the user identifier and modifying the information table indicating the correspondence according to the judgment result.

14. The server allocation method as claimed in claim 12, wherein
the managing server includes: a storage unit for accumulating server utilization history information corresponding to each of the user identifiers linking with the user identifier, and
the managing server ranks the servers in the descending order of the server utilization time length according to the utilization history information accumulated in the storage unit, sets fixed allocation for a predetermined number of servers counted from the one having the longest utilization time, and modifies the information table indicating the correspondence by associating the server with the corresponding user identifier.

15. The server allocation method as claimed in claim 12, wherein the managing server judges whether to employ the fixed allocation method or the dynamic allocation method as the server allocation method according to user profile information corresponding to the user identifier and modifies the information table indicating the correspondence according to the judgment result.

16. The server allocation method as claimed in claim 12, wherein the managing server deletes the information stored in the storage device of the allocated server, according to a utilization end request received from the client when the server allocation method is the dynamic allocation method.

17. The server allocation method as claimed in claim 12, wherein the storage device of the storage system includes fixed server areas to be used by servers of fixed allocation and dynamic server areas to be used by servers of dynamic allocation, and
the managing server transmits an instruction of rearrangement to disperse the fixed server areas and the dynamic server areas in the in the storage device, to the storage system, and
the storage system moves the fixed server areas and the dynamic server areas according to the instruction of rearrangement from the managing server.

18. The server allocation method as claimed in claim 17, wherein
the storage device of the storage system is a physical volume, the fixed server areas and the dynamic server areas correspond to logical volumes in the physical volume, and
the storage management unit moves the logical volumes of the fixed server areas and the logical volumes of the dynamic server areas so that the logical volumes of the fixed server areas and the logical volumes of the dynamic server areas are dispersed in the physical volume.
